(19) United States
(12) Patent Application Publication
(10) Pub. No.: US 2025/0240750 A1
(43) Pub. Date: Jul. 24, 2025

(54) IMPACTLESS ASSOCIATING IN A WIRELESS TIME SENSITIVE NETWORK

(71) Applicants: IMEC VZW, Leuven (BE); UNIVERSITEIT GENT, Gent (BE)

(72) Inventors: Jeroen HOEBEKE, De Pinte (BE); Jetmir HAXHIBEQIRI, Gent (BE); Pablo Esteban AVILA CAMPOS, Gent (BE)

(21) Appl. No.: 18/853,638

(22) PCT Filed: Mar. 30, 2023
(86) PCT No.: PCT/EP2023/058239

§ 371 Date: Oct. 2, 2024

(30) Foreign Application Priority Data
Apr. 13, 2022 (EP) 22168235.4

(51) Int. Cl. H04W 56/00; H04J 3/06

(52) U.S. Cl. CPC H04W 56/005; H04J 3/0667; H04W 56/001

(57) ABSTRACT

A method is for associating a prospective end node to an access point operating according to a wireless time-sensitive networking, W-TSN, mechanism by allocating time slices within a time cycle relative to a time reference to respective associated end nodes. The method includes: i) transmitting, by the access point, beacon frames including: as the time reference, a timestamp when the beacon frame is generated; and pre-schedule information identifying an association time slice within the time cycle relative to the time reference, during which prospective end nodes can exchange frames with the access point for associating; ii) by the prospective end node, receiving the beacon frames; pre-synchronizing with the access point based on the timestamp in at least one of the beacon frames; and identifying the association time slice within the time cycle based on the pre-schedule information; and iii) performing the associating within the association time slice.

### FIELD OF THE INVENTION

The present invention generally relates to the association of an end node in a wireless time sensitive network.

### BACKGROUND OF THE INVENTION

Time-Sensitive Networking, TSN, refers to a group of networking protocols and standards developed by the TSN task group of the IEEE 802.1 working group to provide accurate time synchronization, data delivery with bounded latency, and zero congestion loss in Local Area Networks, LANs. In TSN, the nodes in the network are time synchronized and are assigned a respective time slice for exchanging frames. As such, TSN can enable applications which require reliable and accurately timed data delivery such as, for example, devices in smart factories, devices connected to the Industrial Internet of Things, IIOT, mobile and collaborative robots, autonomous systems, audio and video distribution systems, and virtual or mixed reality applications.

Wireless Time-sensitive Networking, W-TSN, typically refers to a wireless network that extends TSN capabilities over wireless media, e.g. Wi-Fi. Typically, prospective end nodes randomly transmit probe requests to associate with a wireless access point of the network, thereby joining the W-TSN network. These randomly transmitted probe requests can introduce interference in the communication between already associated end nodes and the wireless access point, which should be avoided in W-TSN as it can affect the reliability and timing of data delivery.

It is thus a problem to associate prospective end nodes with an access point in a W-TSN network without impact on the data exchange between already associated end nodes and the access point, i.e. without traffic collisions between associated end nodes and prospective end nodes or without causing delays.

### SUMMARY OF THE INVENTION

It is an object of the present invention, amongst others, to solve or alleviate the above identified challenges and problems by providing impactless associating of a prospective end node to an access point in a wireless time-sensitive network.

According to a first aspect, this object is achieved by a method for associating a prospective end node to an access point in a wireless network. The access point operates according to a wireless time sensitive networking, W-TSN, mechanism by allocating time slices within a time cycle relative to a time reference to respective associated end nodes. The method comprises transmitting, by the access point, beacon frames comprising, as the time reference, a timestamp when the beacon frame is generated; and pre-schedule information identifying an association time slice within the time cycle relative to the time reference, during which prospective end nodes can exchange frames with the access point for associating. The method further comprises, by the prospective end node, receiving the beacon frames; pre-synchronizing with the access point based on the timestamp in at least one of the beacon frames; and identifying the association time slice within the time cycle based on the pre-schedule information. The method further comprises performing the associating to the access point within the association time slice.

The association time slice is thus reserved for the associating of prospective end nodes, during which associated end nodes do not exchange data with the access point, e.g. time-critical data. By the pre-synchronizing, the prospective end node obtains a time reference that substantially matches the time reference of the access point, i.e. within the limits of beacon transmissions. This allows identifying the association time slice within the time cycle based on the pre-schedule information, as the pre-schedule information identifies the association time slice relative to the time reference of the access point. This guarantees that the transmission of frames for associating are restricted to the association time slice, and allows the prospective end node to join the network without affecting, impacting, or interfering with ongoing traffic of already associated end nodes.

It is thus an advantage that the associating is scheduled by the network thereby avoiding traffic collisions between associated end nodes and prospective end nodes. It is a further advantage that the pre-synchronizing of the time reference and the identifying of the association time slice can be performed before establishing a communication channel for the prospective end node. It is a further advantage that the prospective end nodes can identify the association time slice without substantial overhead, as additional transmissions are avoided by including the pre-schedule information and the timestamp in the beacon frames. It is a further advantage that the method is compatible with existing Wi-Fi association procedures.

According to an embodiment, the associating can further comprise synchronizing the prospective end node more accurately with the access point, and/or negotiating a time slice within the time cycle for the prospective end node.

In other words, the prospective end node can exchange data, frames, or packets with the access point during the identified association time slice within the time cycle to perform a more accurate time synchronization. Negotiating and assigning a time slice to the prospective end node can complete the associating. The assigned time slice, during which the prospective end node can exchange frames with the access point, can for example be based on the operational requirements or application requirements of the prospective end node. This synchronizing and/or negotiating can include the exchange of one or more frames during one or more association time slices, i.e. association time slices within successive time cycles.

According to an embodiment, the synchronizing can be performed according to a precision time protocol, PTP, or a network time protocol, NTP.

According to an embodiment, the pre-synchronizing can further comprise adjusting the timestamp to compensate for a delay between the generating of the beacon frame and the receiving of the beacon frame by the prospective end node.

The prospective end node can receive a beacon frame a substantial time after being generated by the access point, i.e. after a delay. By this delay, the timestamp included in the beacon frame no longer represents the current time reference of the access point upon receiving the beacon frame by the prospective end node. By compensating for this delay, the accuracy of the pre-synchronization can be improved. It is thus a further advantage that impactless association of prospective end nodes can be performed in the presence of beacon frame delays.

According to an embodiment, the delay comprises an interframe space, a transmission time of the beacon frame by the access point, and a processing time for receiving the beacon frame by the prospective end node.

The interframe space can relate to a channel access delay for beacon frame transmission, i.e. a minimum wait time between generating and transmitting the beacon frame by the access point. The interframe space can be specified according to a standard, e.g. 28 us according to the IEEE 802.11g standard. The transmission time of the beacon frame can be an elapsed time related to transmitting the beacon frame by the access point. The transmission time can, amongst others, be based on the size of the beacon frame and the data rate at which the beacon frames are transmitted. The processing time can relate to a communication delay between the driver and the physical layer of the prospective end node, i.e. the time to receive and process a beacon frame. The processing time can for example include the time to receive a beacon frame, to parse a beacon frame, to extract the included timestamp and pre-schedule information from the beacon frame, to perform the pre-synchronizing, and/or to perform the identifying of the association time slice. The interframe space, transmission time, and processing time account for the majority of delays between beacon frame generation and receival. Additionally, these delays are predictable and can easily be compensated for by the prospective end node.

According to an embodiment, the beacon frames can further comprise beacon interval information indicative for a time interval between the generation of successive beacon frames.

The access point can be configured to transmit the generated beacon frames as soon as possible, i.e. according to an unscheduled beacon transmission procedure. The beacon frames can be generated periodically by the access point, e.g. at substantially equal time intervals. Information on this time interval between successively generated beacons, i.e. the beacon interval information, can be included in the beacon frame in addition to the timestamp and the pre-schedule information.

According to an embodiment, the beacon frames can further comprise transmission interval information indicative for a time interval between beacon time slices within the time cycle, during which the access point transmits the beacon frames.

The access point can be configured to transmit the generated beacon frames during beacon time slices, i.e. according to a scheduled beacon transmission procedure. The transmission interval can, for example, be the time interval between the start time of successive beacon time slices, or the time interval between the end time of successive beacon time slices. Alternatively or complementary, the transmission interval information can include information for identifying the beacon time slice within the time cycle, e.g. a start time of the beacon time slice or an end time of the beacon time slice. This can allow to derive the time interval and to correct the timestamp of the beacon frames.

According to an embodiment, the method can further comprise identifying delayed beacon frames unsuitable for the pre-synchronizing based on the beacon interval information or the transmission interval information.

A delayed beacon frame can be caused by the unavailability of the channel that transmits the beacon frames, e.g. when the channel is busy with another transmission. Such a delayed beacon frame can be unsuitable for pre-synchronizing as the included timestamp no longer represents the current time reference of the access point upon receiving the beacon frame by the prospective end node. Identifying delayed beacon frames can thus avoid pre-synchronization errors, thereby avoiding untimely or un-synchronized transmission of frames for associating. It is a further advantage that unsuitable beacon frames can be identified under scheduled and unscheduled beacon transmission procedures.

According to an embodiment, the identifying can comprise determining an arrival time difference between successively received beacon frames; and identifying delayed beacon frames when a deviation between the arrival time difference and one or more beacon intervals, or one or more transmission intervals exceeds a threshold.

In other words, the beacon interval or the transmission interval can be compared to the time interval between successively received beacon frames by the prospective end node, i.e. the arrival time difference, before pre-synchronizing. When these respective intervals deviate substantially, i.e. more than the threshold, at least one of the beacon frames can be identified as a delayed beacon frame unsuitable for pre-synchronizing. The prospective end node can then, for example, postpone the pre-synchronizing until suitable beacon frames are received. This allows filtering the received beacon frames without a substantial convergence time, resulting in a reduced association time. This has the further advantage that it can improve user experience by providing substantially fast associating. The arrival time difference can further be compared to a multiple of beacon intervals or transmission intervals, in particular to a multiple of natural numbers. This allows to identify whether non-successively generated beacon frames are delayed, e.g. when one or more generated beacon frames are not received by the prospective end node. It is a further advantage that this makes the method more robust to delayed and lost beacon frames.

According to an embodiment, the beacon frames can further comprise a transmission timestamp of a previous beacon frame indicative for a moment in time when the previous beacon frame was transmitted; and the pre-synchronizing can further be based on the transmission timestamp.

The access point can thus include the transmission timestamp of the previous beacon frame into the current beacon frame. The included transmission timestamp can allow to update or correct the already pre-synchronized time reference of a prospective end node. Alternatively, the time reference of the prospective end node can directly be pre-synchronized based on the transmission timestamp of the previous beacon frame. This results in an accurate time pre-synchronization, thereby guaranteeing that the transmission of frames for associating can be restricted to the association time slice. It is a further advantage that the time pre-synchronization can be accurate with limited overhead in the wireless channel as the transmission timestamp is included in the beacon frames.

According to an embodiment, the method can further comprise identifying non-successive beacon frames based on the transmission timestamp of the previous beacon frame.

Non-successive beacon frames are received successively by the prospective end node but are not successively generated by the access point. In other words, between two successively received beacon frames, one or more generated beacon frames have been lost. This can for example occur, amongst others, when a generated beacon frame is not transmitted, not received, incomplete, or unreadable. Alternatively, a counter can be included in the generated beacon frames to identify non-successive beacon frames. This allows to only perform pre-synchronizing on successive beacon frames, resulting in a more accurate time pre-synchronization.

According to an embodiment, the method can further comprise transmitting, by the access point, a follow-up packet comprising a transmission timestamp of a previous beacon frame indicative for a moment in time when the previous beacon frame was transmitted; and wherein the pre-synchronizing is further based on the transmission timestamp.

The transmission timestamp of the previous beacon frame can thus be provided to the prospective end node by transmitting a frame in addition to the beacon frame, i.e. the follow-up packet. This allows to perform accurate time pre-synchronization without filtering or postprocessing of the received beacon frames as the exact transmission time of the beacon is provided to the prospective end node.

According to an embodiment, the pre-schedule information can comprise at least a cycle length, a start time of the association time slice, and an end time of the association time slice.

The cycle length is indicative for the duration of a time cycle, e.g. 8000 μs. Every cycle length a new time cycle can start. The start time and end time of the association time slice can respectively identify the start and end of the association time slice within the time cycle relative to the start of the time cycle.

According to an embodiment, beacon frames can comprise a dedicated timestamp field containing the timestamp, and one or more information elements fields containing the pre-schedule information.

The pre-schedule information can be included in a vendor specific element within the information elements fields. The vendor specific element allows to provide non-standard information within a defined format such that reserved information element IDs are not replaced for non-standard purposes. This has the advantage that the method remains compatible with the beacon frames according to the IEEE 802.11 standard and non-W-TSN end nodes.

According to an embodiment, the wireless network is operable according to the IEEE 802.11 standard.

According to a second aspect, the invention relates to an access point configured to associate with an end node according to the fourth aspect in a wireless network. The access point is configured to operate according to a wireless time sensitive networking, W-TSN, mechanism by allocating time slices within a time cycle relative to a time reference to respective associated end nodes. The access point configured to perform transmitting beacon frames comprising, as the time reference, a timestamp when the beacon frame is generated; and pre-schedule information identifying an association time slice within the time cycle relative to the time reference, during which end nodes can exchange frames with the access point for associating. The access point further configured to perform the associating with the end node within the association time slice.

According to a third aspect, the invention relates to a method for associating an end node according to the fourth aspect to an access point according to the second aspect. The method comprising, by the access point, transmitting beacon frames comprising, as the time reference, a timestamp when the beacon frame is generated; and pre-schedule information identifying an association time slice within the time cycle relative to the time reference, during which end nodes can exchange frames with the access point for associating. The method further comprising, by the access point, performing the associating with the end node within the association time slice.

According to a fourth aspect, the invention relates to an end node configured to associate with an access point according to the second aspect in a wireless network. The end node is configured to operate, after completing association with the access point, according to a wireless time sensitive networking, W-TSN, mechanism by exchanging traffic with the access point during an allocated time slice within a time cycle relative to a time reference. The end node configured to perform receiving, from the access point, beacon frames comprising, as the time reference, a timestamp when the beacon frame is generated; and pre-schedule information identifying an association time slice within the time cycle relative to the time reference, during which end nodes can exchange frames with the access point for associating. The end node further configured to perform pre-synchronizing with the access point based on the timestamp in at least one of the beacon frames; and identifying the association time slice within the time cycle based on the pre-schedule information; and performing the associating within the association time slice.

According to a fifth aspect, the invention relates to a method for associating an end node according to the fourth aspect to an access point according to the second aspect. The method comprising, by the end node, receiving from the access point, beacon frames comprising, as the time reference, a timestamp when the beacon frame is generated; and pre-schedule information identifying an association time slice within the time cycle relative to the time reference, during which end nodes can exchange frames with the access point for associating. The method further comprising, by the end node, pre-synchronizing with the access point based on the timestamp in at least one of the beacon frames; and identifying the association time slice within the time cycle based on the pre-schedule information; and performing the associating within the association time slice.

According to a sixth aspect, the invention relates to a computer program comprising instructions which, when the program is executed by a computer, cause the computer to perform the method according to the first aspect, the third aspect or the fifth aspect.

According to a seventh aspect, the invention relates to a computer-readable medium comprising instructions which, when executed by a computer, cause the computer to perform the method according to the first aspect, the third aspect or the fifth aspect.

### BRIEF DESCRIPTION OF THE DRAWINGS

FIG. 1 shows an example embodiment of a wireless network that operates according to a wireless time sensitive networking, W-TSN, mechanism;

FIG. 2 shows steps according to a method for associating a prospective end node to an access point in a wireless network that operates according to a wireless time sensitive networking, W-TSN, mechanism, according to an embodiment;

FIG. 3A shows a delay between generating of a beacon frame by an access point and receiving of the beacon frame by a prospective end node;

FIG. 3B shows an example embodiment of a beacon frame generated by an access point that includes the timestamp and the pre-schedule information;

FIG. 4A illustrates an example embodiment of the generation of beacon frames and the respective transmission of these generated beacon frames by an access point, according to an unscheduled beacon transmission procedure;

FIG. 4B illustrates an example embodiment of the generation of beacon frames and the respective transmission of these generated beacon frames by an access point, according to a scheduled beacon transmission procedure;

FIG. 5 illustrates beacon frames generated by the access point that include a transmission timestamp of the previous beacon frame; and

FIG. 6 shows an example embodiment of a suitable computing system for performing steps according to example aspects of the invention.

### DETAILED DESCRIPTION OF EMBODIMENT(S)

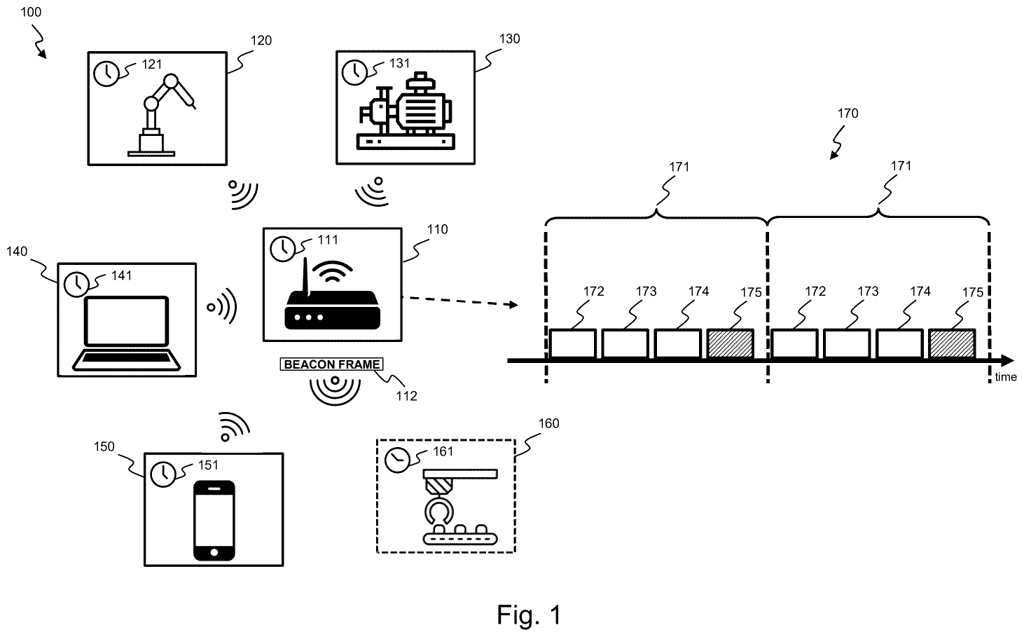

FIG. 1 shows an example embodiment of a wireless network 100 that operates according to a wireless time sensitive networking, W-TSN, mechanism. The network 100 comprises one or more associated end nodes 120, 130, 140, 150 and at least one access point 110. The associated end nodes can be devices 120, 130 performing time-critical and/or crucial operations that require reliable and accurately timed communication. These W-TSN end nodes 120, 130 can for example be manufacturing devices in a smart factory, devices connected to the Internet of Things or Industrial Internet of Things, mobile robots, collaborative robots, autonomous systems, virtual reality devices, mixed reality devices, or any other device that requires time-critical communication known to the skilled person. Additionally, the network 100 can include one or more end nodes 140, 150 that do not perform time-critical and/or crucial operations, i.e. best effort W-TSN end nodes. These best effort W-TSN end nodes 140, 150 can for example be, amongst others, a laptop, a smartphone, a tablet, or a printer.

To provide reliable and time-critical communication in the network 100, the respective associated end nodes 120, 130, 140, 150 and the access point 110 keep a common time reference 111, 121, 131, 141, 151. The common time reference can be a shared timer such as, for example, a timing synchronization function, TSF, timer. In other words, the associated end nodes 120, 130, 140, 150 and the access point 110 are time synchronized. Time references 111, 121, 131, 141, 151 can for example be synchronized, and remain synchronized, by periodically exchanging timing information, e.g. TSF information, between the access point 110 and the associated end nodes 120, 130, 140, 150.

To achieve deterministic communication, the network 100 can further rely on transmission agreements between the access point 110 and the associated end nodes 120, 130, 140, 150, i.e. a schedule 170. The schedule 170 divides the communication time in the network 100 in cyclic time periods of a predetermined length, i.e. time cycles 171. The associated end nodes 120, 130, 140, 150 are allocated or assigned a time slice 172, 173, 174 within each time cycle 171 during which the end nodes 120, 130, 140, 150 can exchange traffic with the access point 110. A dedicated time slice 172, 173 can be assigned to the W-TSN end nodes 120, 130 for low-latency communication. In other words, during a dedicated time slice, e.g. 172, only one specific associated end node, e.g. 120, is permitted to exchange frames with the access point 110. Additionally, a shared time slice 174 can be assigned to the best effort W-TSN end nodes 140, 150, during which a plurality of best effort W-TSN end nodes 140, 150 can exchange frames with the access point 110. Alternatively, the best effort W-TSN end nodes 140, 150 can be assigned a dedicated time slice.

The schedule 170, i.e. time slices 172, 173, 174, is determined relative to the time reference 111 of the access point 110. As the time references 121, 131, 141, 151 of the associated end nodes 120, 130, 140, 150 are synchronized, every associated end node can accurately identify its respective time slice 172, 173, 174 within the time cycle 171 and exchange frames with the access point 110 within that time slice 172, 173, 174.

Typically, an access point 110 in a wireless network periodically transmits or broadcasts beacon frames 112 to announce the presence of the access point 110 to prospective end nodes 160. Such a beacon frame 112 can be any digital data transmission unit that includes information about the capabilities and configuration of a network. The beacon frame 112 can, for example, be a management frame structured according to the IEEE 802.11 standard. A prospective end node 160 refers to an end node, i.e. a client, that wants to join the network 100 but has not yet established a communication channel with the access point 110, i.e. an end node that is not yet associated to access point 110. The prospective end node 160 can become associated to the access point 110 by performing an association procedure.

According to an embodiment, prospective end nodes 160 are configured to only transmit frames for associating during an association time slice 175 within the time cycle 171. In other words, association time slice 175 is a time period within the time cycle 171 that is available for the associating of prospective end nodes 160. Prospective end nodes 160 are thus prohibited to communicate with the access point 110 during any other time slice, e.g. time slices 172, 173, 174. As such, prospective end nodes 160 can join the network 100 without affecting, impacting, or interfering with ongoing traffic of already associated end nodes 120, 130, 140, 150.

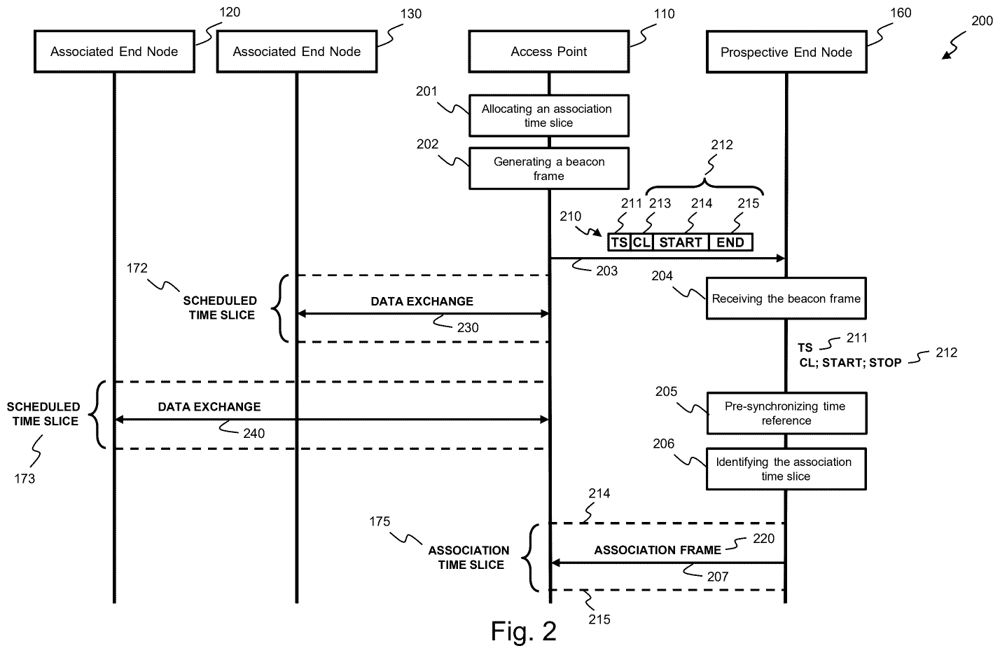

FIG. 2 shows steps 200 according to a method for associating the prospective end node 160 to the access point 110 in the wireless network that operates according to a wireless time sensitive networking, W-TSN, mechanism illustrated in FIG. 1. In a first step 201, an association time slice 175 is allocated or assigned within the time cycle that does not overlap with any of the scheduled time slices 172, 173 assigned to the associated end nodes 110, 120. A dedicated portion of time, i.e. the association time slice 175, is thus assigned to prospective end nodes for association instead of a separate channel. The association time slice 175 can be assigned by a centralized network configuration, CNC, entity that dynamically manages the schedule for the nodes in the network. Alternatively, the association time slice can be assigned by any of the TSN management possibilities according to the IEEE 802.1Qcc standard, or can be assigned by the access point 110.

Pre-schedule information 212 identifies the association time slice 175 within the time cycle. The pre-schedule information 212 can at least include a start time 214 and an end time 215 of the association time slice 175, relative to the time reference of the access point 110. The start time 214 and end time 215 can for example determine the start and end of the association time slice 175 relative to the start of the time cycle. For example, the start time 214 can be 6000 μs after the start of a new time cycle and the end time 215 can be 7000 μs after the start of a new time cycle. The pre-schedule information 212 can further at least include the cycle length 213 of the time cycle. The cycle length 213 is indicative for the duration of the time cycle, e.g. 8000 μs. As the time cycle is a cyclic time period, a new time cycle is initiated every time a cycle length 213 passes, as long as the access point 110 is operational.

In a next step 202, the access point 110 generates a beacon frame 210 that includes the pre-schedule information 212 and a timestamp 211. The timestamp 211 is indicative for the moment in time when the beacon frame 210 is generated, i.e. the timestamp 211 represents the time reference of the access point 110 upon beacon generation. Beacon frames 210 can be generated periodically by the access point 110, i.e. at substantially equal time intervals. Alternatively or complementary, beacon frames 210 can be generated at variable time intervals, e.g. triggered by an event, and/or at random time intervals.

In a next step 203, the access point 110 transmits the generated beacon frame 210. The access point 110 can be configured to transmit a generated beacon frame 210 as soon as possible after generation, i.e. according to an unscheduled beacon transmission procedure. Alternatively, the access point 110 can be configured to transmit a generated beacon frame 210 during a beacon time slice within the time cycle, i.e. according to a scheduled beacon transmission mechanism.

In a following step 204, a prospective end node 160 receives the transmitted beacon frame 210. The prospective end node 160 is configured to extract the pre-schedule information 212 and the timestamp 211 from the received beacon frame 210. The prospective end node 160 can further be configured to prevent transmission of frames for associating before pre-synchronization and identification of the association time slice 175 is performed. This can, for example, be achieved by suppressing the transmission of association frames or by delaying a set channel event.

In a succeeding step 205, the time reference of the prospective end node 160 is pre-synchronized with the time reference of the access point 110 based on the extracted timestamp 211. Pre-synchronization can for example be achieved by overwriting the time reference of the prospective end node 160 with the extracted timestamp 211 value. The time reference of the prospective end node 160 can thus be matched to the time reference of the access point 110 within the limits of the beacon frame transmission, i.e. depending on how soon the beacon frame is received after including the timestamp. The time reference of the prospective end node 160 can for example be a local time synchronization function, TSF, timer.

By the pre-synchronization, the association time slice 175 can be identified based on the extracted pre-schedule information 212 in step 206, as the pre-schedule information 212 identifies the association time slice 175 relative to the time reference of the access point 110. In other words, the pre-schedule information 212 can be used to identify the association time slice 175 as the time reference of the prospective end node 160 substantially matches the time reference of the access point 110 after pre-synchronizing. As the pre-schedule information 212 includes the start 214 and end time 215 of the association time slice 175 relative to the start of the time cycle, the start of the time cycle should be determined. The start of the time cycle can be determined based on the cycle length 213 included in the pre-schedule information 212, as a new time cycle is initiated every cycle length 213. For example, when the cycle length is 8000 μs, a new time cycle starts every time the pre-synchronized time reference of the prospective end node reaches a multiple of 8000 μs.

In a following step 207, associating is performed during the association time slice 175. The associating can, for example, be initiated by transmitting an association frame 220 from the prospective end node 160 to the access point 110 within the association time slice 175. The association frame 220 can for example be an authentication request or an association request. To this end, a gating system of the prospective end node 160 that controls the access to the transmission medium can for example be configured to only allow associating frame transmission during the association time slice 175. The associating is thus scheduled by the network and initiated by the prospective end node 160.

The method allows to pre-synchronize the prospective end node 160 and identify the association time slice 175 before establishing or negotiating a communication channel for the prospective end node 130. This allows to only transmit frames for associating during the association time slice 175 without affecting traffic of associated end nodes 120, 130. In other words, transmitting frames for associating during the time slices assigned to the associated end nodes 110, 120 is avoided.

It is thus an advantage that the associating is scheduled by the network 100, thereby avoiding traffic collision between associated end nodes 120, 130 and prospective end nodes 160. It is a further advantage that the pre-synchronizing of the time reference and the identifying of the association time slice 175 can be performed before establishing a communication channel for the prospective end node 160. It is a further advantage that the prospective end nodes 160 can identify the association time slice 175 without substantial overhead, as additional transmissions are avoided by including the pre-schedule information 212 and the timestamp 211 in the beacon frames 210. It is a further advantage that the method is compatible with existing IEEE 802.11 association procedures.

The associating can further comprise, amongst others, receiving an authentication response from the access point 110, receiving an association response from the access point 110, synchronizing the prospective end node 160 more accurately, and negotiating a time slice within the time cycle for traffic exchange with the prospective end node 160. The more accurate synchronizing can, amongst others, be performed according to a precision time protocol, PTP, or a network time protocol, NTP. The time slice for the prospective end node 160 can for example be negotiated in-band, and can be based on the operational requirements or application requirements of the prospective end node 160. The associating can be completed by assigning the time slice to the prospective end node 160, by which the prospective end node 130 becomes an associated end node 120, 130.

During the associating, the prospective end node 160 can exchange one or more frames with the access point 110 during one or more association time slices 175, i.e. association time slices 154 within successive time cycles. The time reference of the prospective end node 160 can further be kept accurate during the association procedure by periodically repeating the pre-synchronizing. In other words, the pre-synchronized time reference of the prospective end node 160 can be updated when succeeding beacon frames 210 are received.

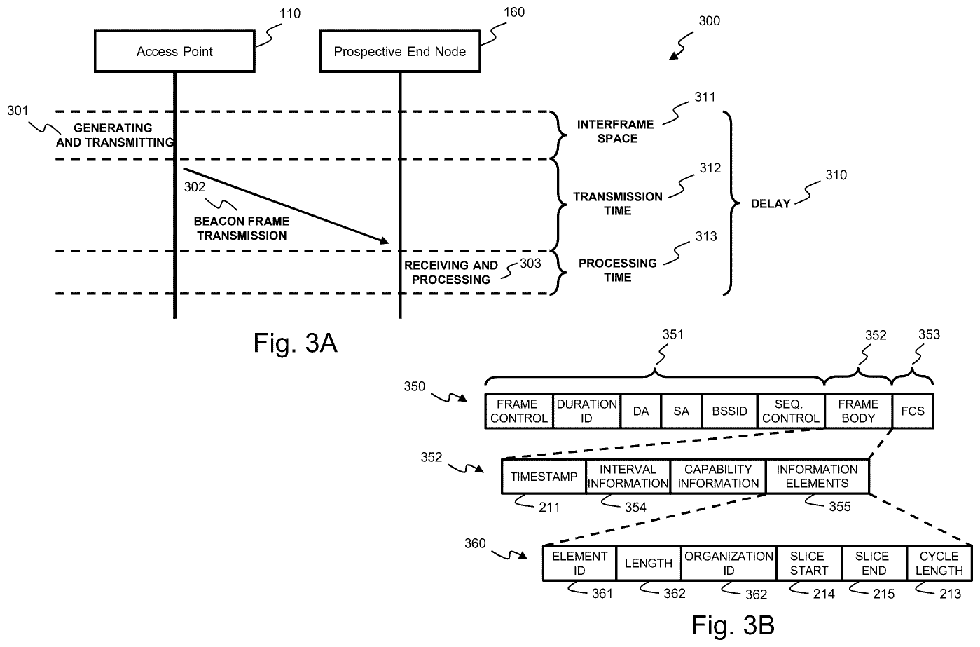

FIG. 3A shows a delay 310 between generating 301 of the beacon frame by the access point 110 and receiving 303 of the beacon frame 210 by the prospective end node 160. By this delay 310, the timestamp included in the beacon frame no longer represents the current time reference of the access point 110 upon receiving the beacon frame. As such, the pre-synchronizing can further comprise adjusting the timestamp to compensate for the delay 310. The adjusting can, for example, comprise adding delay 310 to the timestamp before overwriting the time reference of the prospective end node 160 with the extracted timestamp 211 value, i.e. before pre-synchronizing. This can improve the accuracy of the pre-synchronization and allows to perform impactless association of prospective end nodes in the presence of beacon frame delays 310.

The compensated delay 310 can comprise an interframe space 311, a transmission time 312 of the beacon frame by the access point 110, and a processing time 313 for receiving the beacon frame by the prospective end node 160. The interframe space 311 can include a channel access delay for beacon frame transmission, i.e. a minimum wait time between generating and transmitting the beacon frame by the access point 110. The interframe space 311 can be specified according to a standard, e.g. 28 μs according to the IEEE 802.11g standard.

The transmission time 312 of the beacon frame can be the elapsed time between transmitting the beacon frame by the access point 110 and receiving the beacon frame by the prospective end node 160. Alternatively, the transmission time 312 can be the elapsed time between the beginning of transmitting the beacon frame by the access point 110 and the end of the transmitting. The transmission time 312 can for example, amongst others, be based on the size of the beacon frame and the data rate at which the beacon frames are transmitted. For example, considering a beacon frame size of 148 bytes transmitted at a default data rate of 6 Mbps results in a transmission time 312 of around 197.33 μs.

The processing time 313 can relate to a communication delay between the driver and the physical layer of the prospective end node 160, i.e. the time to receive and process a beacon frame. The processing time 313 can for example include the elapsed time to dispatch a beacon frame, to parse the beacon frame, to extract the included timestamp and pre-schedule information from the beacon frame, to perform the pre-synchronizing, and/or to perform the identifying of the association time slice, i.e. steps 204, 205, and 206 in FIG. 2. The processing time 313 can for example be between 15 μs and 30 μs.

FIG. 3B shows an example embodiment of a beacon frame 350 generated by the access point 110 that includes the timestamp 211 and the pre-schedule information 213, 214, 215. The beacon frame 350 can be any digital data transmission unit that includes information about the capabilities and configuration of a network. Preferably, the beacon frame 350 can be structured according to the IEEE 802.11 standard, comprising a media access control, MAC, header 351, a frame body 352, and a frame check sequence 353, FCS. The timestamp 211 indicative for when the beacon frame is generated can be included in a dedicated timestamp field of the frame body 352. The frame body 352 can further comprise information elements 355, IE, that provide specific information to end nodes.

Amongst others, the information elements 355 can include one or more vendor specific elements 360. A vendor specific element allows to provide information not defined in the IEEE 802.11 standard within a single defined format, such that reserved information element IDs are not replaced for non-standard purposes. The first three octets of the vendor specific element 360 can include the element ID 361, the length 362, and the organization ID 362, followed by the pre-schedule information 213, 214, 215 to identify the association time slice. This has the advantage that the method remains compatible with the standard IEEE 802.11 beacon frame format and non-W-TSN end nodes. In other words, it is an advantage that beacon frames 350 according to existing standards can be used such as, for example, the IEEE 802.11 standard.

The generated beacon frame 350 can further comprise an interval information field 354 that contains beacon interval information indicative for a time interval between the generation of successive beacon frames, i.e. a beacon interval. In particular, the beacon interval information can be included when beacons are transmitted according to an unscheduled beacon transmission procedure. Alternatively, the interval information field 354 can contain transmission interval information indicative for a time interval, i.e. a transmission interval, between beacon time slices within the time cycle during which the access point transmits the beacon frames. In particular, the transmission interval information can be included when beacons are transmitted according to a scheduled beacon transmission protocol.

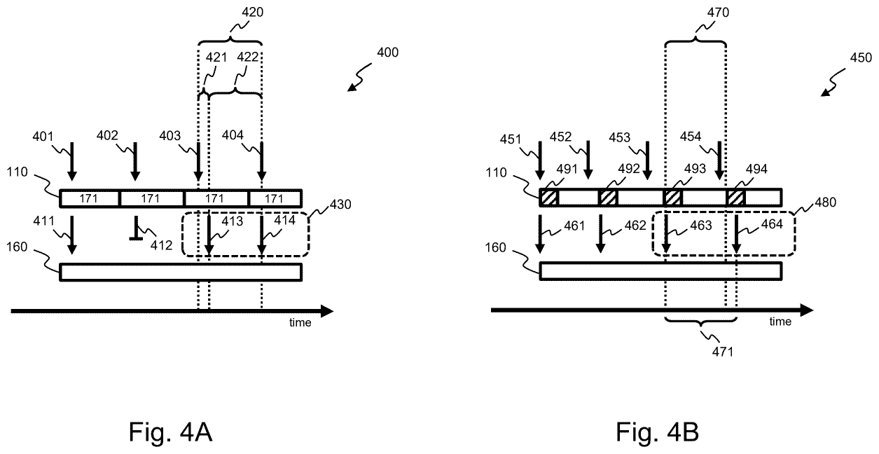

FIG. 4A illustrates the generation 401, 402, 403, 404 of beacon frames and the respective transmission 411, 412, 413, 414 of these generated beacon frames by the access point 110, according to an unscheduled beacon transmission procedure 400. The beacon frames can be generated periodically by the access point 110 at substantially equal time intervals, i.e. the beacon interval 420. The beacon frames can be transmitted 411, 413, 414 as soon as possible after being generated 401, 402, 403, 404, thereby the included timestamp can accurately represent the current time reference of the access point 110 when the beacon frame is received by the prospective end node 160.

The method can further comprise identifying delayed beacon frames, e.g. 413, based on the beacon interval information included in the beacon frames. A delayed beacon frame 413 can be a beacon frame that is received substantially later than the compensated delay 310 illustrated in FIG. 3A, e.g. received a period 421 after generation. Such a delayed beacon frame 413 can be unsuitable for pre-synchronizing as the included timestamp no longer represents the current time reference of the access point 110 upon receiving the beacon frame by the prospective end node 160. Identifying delayed beacon frames 413 before pre-synchronizing can thus avoid pre-synchronization errors, thereby avoiding untimely or un-synchronized transmission of frames for associating.

The identifying of delayed beacon frames can comprise comparing the beacon interval 420 with the arrival time difference 422 of two successively received beacon frames, e.g. 411 and 413, or 413 and 414. The identifying can preferably be performed according to a moving window 430 wherein the two most recently received beacon frames are compared, i.e. 413 and 414. When the deviation between the beacon interval 420 and the arrival time difference 422 exceeds a threshold, the compared beacon frames can be identified as delayed beacon frames unsuitable for pre-synchronizing. This allows to filter the received beacon frames without a substantial convergence time, for example compared to a proportional integral derivative, PID, control loop, resulting in a reduced association time. This has the further advantage that it can improve user experience by providing substantially fast associating. The threshold can for example be substantially equal to the compensated delay, or can be substantially larger than the compensated delay. The threshold can preferably be at most 10 μs, more preferably at most 5 μs, or even more preferably at most 2 μs. When identifying delayed beacon frames, the prospective end node 160 can for example postpone the pre-synchronizing until suitable beacon frames are received.

FIG. 4B illustrates the generation 451, 452, 453, 454 of beacon frames by the access point 110 and the respective transmission 461, 462, 463, 464 of these generated beacon frames, according to a scheduled beacon transmission procedure 450. As such, the access point 110 is configured to only transmit beacon frames 461, 462, 463, 464 during scheduled beacon time slices 491, 492, 493, 494 within the time cycles. Information on the time interval between two successive beacon time slices, i.e. the transmission interval information, can be included in the beacon frame in addition to the timestamp and the pre-schedule information. The transmission interval 470 can, for example, be the time interval between the start time of successive beacon time slices 491, 492, 493, 494, or the time interval between the end time of successive beacon time slices 491, 492, 493, 494. Alternatively or complementary, the transmission interval information can include information for identifying the beacon time slice 491, 492, 493, 494 within the time cycle, e.g. a start time of the beacon time slice or an end time of the beacon time slice. This start and end time can for example be specified by, amongst others, an offset relative to the start of the time cycle. This information can then allow to derive the time interval, to correct the timestamp of the beacon frames, and/or to improve the pre-synchronization.

The method can further comprise identifying delayed beacon frames based on the transmission interval information included in the beacon frames. The identifying can comprise comparing the transmission interval 470 with the arrival time difference 471 of two successively received beacon frames, e.g. 461 and 462, or 463 and 464. The identifying can preferably be performed according to a moving window 480, wherein the two most recently received beacon frames are compared, i.e. 463 and 464. When the deviation between the transmission interval 470 and the arrival time difference 471 exceeds a threshold, the compared beacon frames can be identified as delayed beacon frames unsuitable for pre-synchronizing. The threshold can for example be substantially equal to the compensated delay, or can be substantially larger than the compensated delay. The threshold can preferably be at most 10 μs, more preferably at most 5 μs, or even more preferably at most 2 μs. The prospective end node 160 can then, for example, postpone the pre-synchronizing until suitable beacon frames are received. Identifying delayed beacon frames before pre-synchronizing can thus avoid pre-synchronization errors, thereby avoiding untimely or un-synchronized transmission of frames for associating.

Both in unscheduled 400 and scheduled 450 beacon transmission, the arrival time difference 422, 471 can further be compared to a multiple of beacon intervals 420 or transmission intervals 470, respectively. In particular, the multiple may be a natural number, e.g. two or three. This allows to identify whether non-successive beacon frames are delayed. Non-successive beacon frames are received successively by the prospective end node 160 but are not successively generated by the access point 110. In other words, between two successively received beacon frames, one or more generated beacon frames are missing. This can for example occur, amongst others, when a generated beacon frame is not transmitted by the access point 110, not received by the prospective end node 160, incomplete, corrupted, or unreadable. For example, 411 and 413 are non-successive beacon frames as generated beacon frame 402 was not received 412 by the prospective end node 160. As such, comparing the arrival time difference between received beacon frames 411 and 413 to a multiple of beacon intervals 420, i.e. two intervals, allows to identify whether the non-successive beacon frames are delayed.

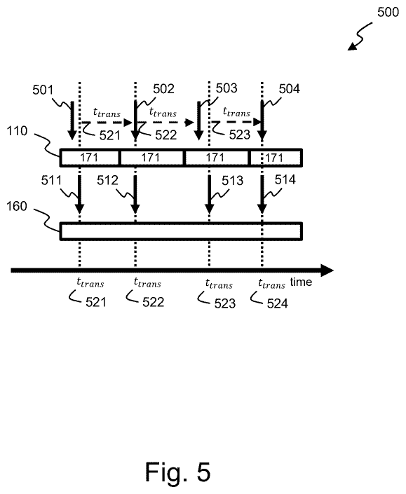

To provide accurate time pre-synchronization in the presence of non-successive beacon frames, a transmission timestamp of a previous beacon frame can be included in the current beacon frame. FIG. 5 illustrates beacon frames 502, 503, 504 generated by the access point 110 that include the transmission timestamp 521, 522, 523 of the previous beacon frame. The transmission timestamp 521, 522, 523 can be indicative for the moment in time when the previous beacon frame was transmitted.

The transmission timestamp 521, 522, 523 can allow to update or correct the time reference of an already pre-synchronized prospective end node 160. For example, prospective end node 160 may already be pre-synchronized based on the timestamp extracted from beacon frame 511. That timestamp represents the time reference of the access point 110 when the received beacon frame 511 was generated, i.e. 501. By including the transmission timestamp 521 of the received beacon frame 511 in the next generated beacon frame 502, the prospective end node 160 receives the actual transmission time of beacon frame 511. As such, the prospective end node 160 can adjust the pre-synchronized time reference with the difference between the timestamp previously extracted from beacon frame 511 and the transmission timestamp 521 included in beacon frame 512, i.e. the difference between the generation time and transmission time of the previous beacon frame. Alternatively, the time reference of the prospective end node 160 can directly be pre-synchronized based on the transmission timestamp 521, 522, 523 of the previous beacon frame. It is a further advantage that the time pre-synchronization can be accurate with limited overhead in the wireless channel as the transmission timestamp 521, 522, 523 is included in the beacon frames.

Additionally, non-successive beacon frames can be identified based on the transmission timestamps 521, 522, 523. Alternatively, a counter can be included in the generated beacon frames to identify non-successive beacon frames. Identifying non-successive beacon frames allows to only perform pre-synchronizing on successive beacon frames, resulting in a more accurate time pre-synchronization.

Alternatively, the transmission timestamp of the previous beacon frame can be included in a follow-up packet. The follow-up packet can be transmitted or broadcasted by the access point 110 in addition to the beacon frame, e.g. a substantially small period after transmitting the beacon frame. This can allow to perform accurate time pre-synchronization without filtering or postprocessing of the received beacon frames. This further allows to provide the exact transmission time of the beacon frame sooner to the prospective end node 160 compared to including the transmission timestamp in the next beacon frame. This has the further advantage that time drift can be reduced and that overcorrection can be avoided.

It will be apparent to the skilled person that, even though FIG. 5A illustrates an unscheduled beacon transmission procedure, the transmission timestamps of a previous beacon frame can also be included in a next beacon frame or in a follow-up packet when the beacons are transmitted according to a scheduled beacon transmission procedure.

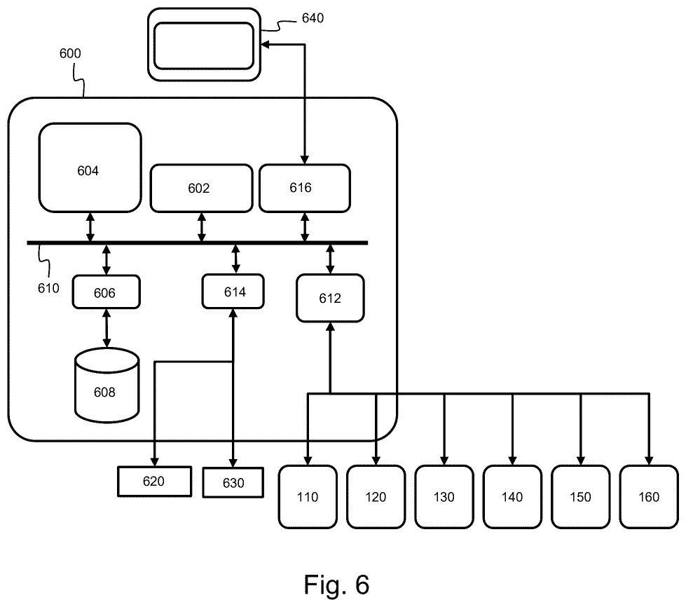

FIG. 6 shows a suitable computing system 600 enabling to implement embodiments of the above described method according to the invention. Computing system 600 may in general be formed as a suitable general-purpose computer and comprise a bus 610, a processor 602, a local memory 604, one or more optional input interfaces 614, one or more optional output interfaces 616, a communication interface 612, a storage element interface 606, and one or more storage elements 608. Bus 610 may comprise one or more conductors that permit communication among the components of the computing system 600. Processor 602 may include any type of conventional processor or microprocessor that interprets and executes programming instructions. Local memory 604 may include a random-access memory (RAM) or another type of dynamic storage device that stores information and instructions for execution by processor 602 and/or a read only memory (ROM) or another type of static storage device that stores static information and instructions for use by processor 602. Input interface 614 may comprise one or more conventional mechanisms that permit an operator or user to input information to the computing device 600, such as a keyboard 620, a mouse 630, a pen, voice recognition and/or biometric mechanisms, a camera, etc. Output interface 616 may comprise one or more conventional mechanisms that output information to the operator or user, such as a display 640, etc. Communication interface 612 may comprise any transceiver-like mechanism such as for example one or more Ethernet interfaces that enables computing system 600 to communicate with other devices and/or systems such as for example, amongst others, an access point 110 or an end node 120, 130, 140, 150, 160. The communication interface 612 of computing system 600 may be connected to such another computing system by means of a local area network (LAN) or a wide area network (WAN) such as for example the internet. Storage element interface 606 may comprise a storage interface such as for example a Serial Advanced Technology Attachment (SATA) interface or a Small Computer System Interface (SCSI) for connecting bus 610 to one or more storage elements 608, such as one or more local disks, for example SATA disk drives, and control the reading and writing of data to and/or from these storage elements 608. Although the storage element(s) 608 above is/are described as a local disk, in general any other suitable computer-readable media such as a removable magnetic disk, optical storage media such as a CD or DVD, -ROM disk, solid state drives, flash memory cards, etc. could be used.

Although the present invention has been illustrated by reference to specific embodiments, it will be apparent to those skilled in the art that the invention is not limited to the details of the foregoing illustrative embodiments. The invention is defined by the appended claims. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1.-15. (canceled)

16. A method for associating a prospective end node to an access point in a wireless network;
wherein the access point operates according to a wireless time sensitive networking, W-TSN, mechanism by allocating time slices within a time cycle relative to a time reference to respective associated end nodes; the method comprising:
transmitting, by the access point, beacon frames comprising:
as the time reference, a timestamp when the beacon frame is generated; and
pre-schedule information identifying an association time slice within the time cycle relative to the time reference, during which prospective end nodes can exchange frames with the access point for associating;
by the prospective end node, receiving the beacon frames; pre-synchronizing with the access point based on the timestamp in at least one of the beacon frames; and identifying the association time slice within the time cycle based on the pre-schedule information; and
performing the associating to the access point within the association time slice.

17. The method according to claim 16, wherein the associating further comprises synchronizing the prospective end node more accurately with the access point, and/or negotiating a time slice within the time cycle for the prospective end node.

18. The method according to claim 17, wherein the synchronizing is performed according to a precision time protocol, PTP, or a network time protocol, NTP.

19. The method according to claim 16, wherein the pre-synchronizing further comprises adjusting the timestamp to compensate for a delay between the generating of the beacon frame and the receiving of the beacon frame by the prospective end node.

20. The method according to claim 19, wherein the delay comprises an interframe space, a transmission time of the beacon frame by the access point, and a processing time for receiving the beacon frame by the prospective end node.

21. The method according to claim 16, wherein the beacon frames further comprise beacon interval information indicative for a time interval between the generation of successive beacon frames; or
wherein the beacon frames further comprise transmission interval information indicative for a time interval between beacon time slices within the time cycle, during which the access point transmits the beacon frames.

22. The method according to claim 21, further comprising identifying delayed beacon frames unsuitable for the pre-synchronizing based on the beacon interval information or the transmission interval information.

23. The method according to claim 22, wherein the identifying comprises:
determining an arrival time difference between successively received beacon frames; and
identifying delayed beacon frames when a deviation between the arrival time difference and one or more beacon intervals, or one or more transmission intervals exceeds a threshold.

24. The method according to claim 16, wherein the beacon frames further comprise a transmission timestamp of a previous beacon frame indicative for a moment in time when the previous beacon frame was transmitted; and
wherein the pre-synchronizing is further based on the transmission timestamp.

25. The method according to claim 24, further comprising identifying non-successive beacon frames based on the transmission timestamp of the previous beacon frame.

26. The method according to claim 16, further comprising transmitting, by the access point, a follow-up packet comprising a transmission timestamp of a previous beacon frame indicative for a moment in time when the previous beacon frame was transmitted; and
wherein the pre-synchronizing is further based on the transmission timestamp.

27. An access point configured to associate an end node in a wireless network;
wherein the access point is configured to operate according to a wireless time sensitive networking, W-TSN, mechanism by allocating time slices within a time cycle relative to a time reference to respective associated end nodes; the access point configured to perform:
transmitting beacon frames comprising:
as the time reference, a timestamp when the beacon frame is generated;
pre-schedule information identifying an association time slice within the time cycle relative to the time reference, during which end nodes can exchange frames with the access point for associating; and
performing the associating with the end node within the association time slice.

28. An end node configured to associate with an access point in a wireless network;
wherein the end node is configured to operate, after completing association with the access point, according to a wireless time sensitive networking, W-TSN, mechanism by exchanging traffic with the access point during an allocated time slice within a time cycle relative to a time reference; the end node configured to perform:
receiving, from the access point, beacon frames comprising:
as the time reference, a timestamp when the beacon frame is generated;
pre-schedule information identifying an association time slice within the time cycle relative to the time reference, during which end nodes can exchange frames with the access point for associating;
pre-synchronizing with the access point based on the timestamp in at least one of the beacon frames; and identifying the association time slice within the time cycle based on the pre-schedule information; and
performing the associating within the association time slice.

29. A computer program comprising instructions which, when the program is executed by a computer, cause the computer to perform the method according to claim 16.

30. A computer-readable medium comprising instructions which, when executed by a computer, cause the computer to perform the method according to claim 16.
